(19) United States
(12) Patent Application Publication
(10) Pub. No.: US 2015/0235159 A1
(43) Pub. Date: Aug. 20, 2015

(54) SYSTEM AND METHOD FOR CONTACT CENTER AGENT GUIDANCE WITH FEEDBACK

(71) Applicant: NICE-SYSTEMS LTD., Ra'anana (IL)

(72) Inventors: David GEFFEN, Givat Shmuel (IL); Yizhar RONEN, Hod HaSharon (IL); Hovav LAPIDOT, Kiryat Tivon (IL); Ohad POLLAK, Zichron Yaacov (IL); Nadav DORON, Kfar Saba (IL)

(73) Assignee: NICE-SYSTEMS LTD., Ra'anana (IL)

(21) Appl. No.: 14/184,728

(22) Filed: Feb. 20, 2014

(51) Int. Cl. G06Q 10/06

(52) U.S. Cl. CPC G06Q 10/06395

(57) ABSTRACT

In a method for providing guidance to agents of a contact center, a server of an agent guidance system provides a list of key selling points to a plurality of workstations. Each of the workstations is associated with an agent of the contact center. Each key selling point of the list is associated with an effectiveness status. The server receives from a workstation feedback related to an effectiveness of a key selling point of the list. The effectiveness status of a key selling point of the list is automatically modified in accordance with the received feedback. The server provides to the workstations a modified list that incorporates the modified effectiveness status.

### FIELD OF THE INVENTION

The present invention relates to a system and method guidance for agents at a contact center that incorporates real-time feedback.

### BACKGROUND

Customer service representatives or agents at a contact center of a company are typically humans (but automated processes exist) tasked with providing services to callers, typically via telephone but also via computer chat, texting, e-mail, or other methods. For example, the services may involve tasks involving a high level of expertise, such as troubleshooting a device or computer application that is provided or maintained by the company, or simpler tasks, such as assisting a customer in completing a form. Agents may also be tasked with utilizing the interaction with the customer to generate additional business for the company. It has been suggested that an offer (e.g., to purchase an additional service or product that is provided by a company) is much more effective when the customer has initiated contact than when a company representative initiates the contact.

Agents typically are trained in technical aspects of the company's products or services. Agents may not be trained or experienced in sales, marketing, or other business aspects of the company. Thus, when tasked with generating additional business for the company, they may benefit from real-time assistance with these tasks. For example, a desk or workstation that is manned by the agent may be provided with a guidance application that is configured to offer such assistance.

### SUMMARY

There is thus provided, in accordance with some embodiments of the present invention, A method for providing guidance to agents of a contact center, the method including: providing by a server of an agent guidance system a list of key selling points to a plurality of workstations, each of the workstations associated with an agent of the agents of the contact center, each key selling point of the list being associated with an effectiveness status; receiving by the server from a workstation of the plurality of workstations feedback related to an effectiveness of a key selling point of the list; automatically modifying the effectiveness status of a key selling point of the list in accordance with the received feedback; and providing by the server to the plurality of workstations a modified list that incorporates the modified effectiveness status.

Furthermore, in accordance with some embodiments of the present invention, a position of a key selling point of the list within the list indicates an effectiveness status that is associated with that key selling point.

Furthermore, in accordance with some embodiments of the present invention, providing the list of key selling points includes displaying the list on an output device of a workstation of the plurality of workstations.

Furthermore, in accordance with some embodiments of the present invention, a font with which a key selling point of the list is displayed is indicative of the effectiveness status of that key selling point.

Furthermore, in accordance with some embodiments of the present invention, the effectiveness status of a key selling point of the list includes a number of agents that have indicated approval of that key selling point.

Furthermore, in accordance with some embodiments of the present invention, receiving the feedback includes receiving an indication of approval or of disapproval.

Furthermore, in accordance with some embodiments of the present invention, providing the list of key selling points includes displaying a number of the received indications of approval or of disapproval.

Furthermore, in accordance with some embodiments of the present invention, providing the modified list includes updating a presented total of indications of approval or of disapproval.

Furthermore, in accordance with some embodiments of the present invention, receiving the feedback includes receiving a comment.

Furthermore, in accordance with some embodiments of the present invention, the method further includes forwarding the received comment to a supervisor workstation.

Furthermore, in accordance with some embodiments of the present invention, the effectiveness status is initially determined at a supervisor workstation.

There is further provided, in accordance with some embodiments of the present invention, a non-transitory computer readable storage medium having stored thereon instructions that when executed by a processor cause the processor to perform the operations of: providing a list of key selling points to a plurality of workstations, each of the workstations associated with an agent of the agents of the contact center, each key selling point of the list being associated with an effectiveness status; receiving from a workstation of the plurality of workstations feedback related to an effectiveness of a key selling point of the list; modifying the effectiveness status of a key selling point of the list in accordance with the received feedback; and providing to the plurality of workstations a modified list that incorporates the modified effectiveness status.

Furthermore, in accordance with some embodiments of the present invention, the instructions include instruction to display the list or the modified list so as to indicate the effectiveness status of a key selling point of the list.

Furthermore, in accordance with some embodiments of the present invention, the effectiveness status is indicated by a position of that key selling point in the displayed list or modified list, or by a displayed number of received indications of approval.

Furthermore, in accordance with some embodiments of the present invention, the instructions for receiving feedback include instruction to receive an indication of approval or disapproval from a workstation of the plurality of workstations.

There is further provided, in accordance with some embodiments of the present invention, an agent guidance system including: a computer readable medium; and

a processor of the server, the processor being in communication with the computer readable medium, wherein the computer readable medium contains a set of instructions which when executed by the processor cause the processor to: provide a list of key selling points to a plurality of workstations in communication with the server, each of the workstations being connectable via a network to a customer device, each key selling point of the list being associated with an effectiveness status; receive from a workstation of the plurality of workstations feedback related to an effectiveness of a key selling point of the list; modify the effectiveness status of a key selling point of the list in accordance with the received feedback; and provide to the plurality of workstations a modified list that incorporates the modified effectiveness status.

Furthermore, in accordance with some embodiments of the present invention, the system further includes a supervisor workstation in communication with the server.

Furthermore, in accordance with some embodiments of the present invention, a workstation of the plurality of workstations includes an output device for displaying the list or the modified list.

Furthermore, in accordance with some embodiments of the present invention, a workstation of the plurality of workstations includes an input device for enabling an agent that operates the station to enter the feedback

Furthermore, in accordance with some embodiments of the present invention, the network includes a telephone network.

### BRIEF DESCRIPTION OF THE DRAWINGS

In order to better understand the present invention, and appreciate its practical applications, the following Figures are provided and referenced hereafter. It should be noted that the Figures are given as examples only and in no way limit the scope of the invention. Like components are denoted by like reference numerals.

FIG. 1 is a schematic illustration of a system for contact center agent guidance, in accordance with an embodiment of the present invention.

FIG. 2 is a schematic illustration of a server of the system shown in FIG. 1.

FIG. 3 is a flowchart of a method for agent guidance, in accordance with an embodiment of the present invention.

FIG. 4 is a schematic illustration of a user interface for contact center agent guidance that incorporates agent feedback, in accordance with an embodiment of the present invention.

### DETAILED DESCRIPTION

In the following detailed description, numerous specific details are set forth in order to provide a thorough understanding of the invention. However, it will be understood by those of ordinary skill in the art that the invention may be practiced without these specific details. In other instances, well-known methods, procedures, components, modules, units and/or circuits have not been described in detail so as not to obscure the invention.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium (e.g., a memory) that may store instructions to perform operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently.

In accordance with embodiments of the present invention, an agent guidance system may be configured to provide guidance to an agent of a contact center of a company. The guidance includes a list of options for action by an agent during an interaction with a customer. Typically, the action for which guidance is provided includes offering for sale or promotion of a product or service that is offered by the company.

For example, the agent guidance application may present the agent with a displayed list of offered products or services that the agent is tasked with promoting during an interaction with a customer. The displayed lists may appear for example as popup screens or boxes on a display screen that may be viewed by the agent during the interaction. The list may be displayed at an appropriate point during interaction. For example, the list may be displayed after indication of a nature or subject matter of the interaction, or after indication of reaching a predetermined point (e.g., solution of problem or referral to another party) during the interaction.

The guidance application may also present the agent with a list of selling points or key selling points regarding each listed product or service. A key selling point may include for example content or text of a suggested statement to be made by the agent to the customer in order to persuade the customer to purchase the offered product or service.

The action is considered to be successfully completed when the customer purchases, or agrees to purchase (to be understood herein as including lease or other arrangement in which use of the product or service is enabled in return for payment), the offered product or service. The listed options typically key selling points in the form of statements or arguments (e.g., in rebuttal to statements made by the customer) that are intended to be conveyed by the agent to the customer during the interaction. Action in accordance with the option is intended to increase the likelihood that the customer will purchase the product or service. (Unless otherwise indicated, the term “product” as used hereinafter is to be understood as referring to either a product or a service.)

The listed options are each associated with an effectiveness status. The effectiveness status may include a ranking, rating, score, or other indication of at least relative effectiveness or efficacy of each of the listed options. The agent guidance system may be configured to solicit feedback from each agent who acts in accordance with one of the options. The solicited feedback may relate to the efficacy of the agent's action in accordance with a selected option. For example, efficacy of an option may relate to the likelihood that action in accordance with that option results in a purchase by the customer. The feedback may be analyzed and the ranking of one or more of the listed options may be modified in accordance with a result of the analysis. The modified ranking may then be communicated for example immediately or in real time, or at another time, via the system to each agent of the contact center.

As referred to herein, a contact center refers to a physical or virtual center to which a customer of a company may initiate contact. The customer typically contacts the contact center in order to request or receive a service from the contact center. A period of time during which the customer is in contact with, or communicates with, the contact center is herein referred to as an interaction or contact session. During the interaction, the customer may communicate with one or more people (herein referred to as agents) for the purpose of receiving the service.

For example, a contact center may include one or more physical centers in which some or all of the agents are in close proximity to one another (e.g., in a single campus or building complex, building, hall, or room). As another example, a contact center may include agents that are at separate locations but that communicate with one another, or with a common (to all or to a subset of the agents) location or server, via a network. The network may include, for example, a network that is dedicated for use by the contact center, a telephone network, the Internet, or another suitable network.

Each agent is provided with a workstation that includes one or more devices (e.g., telephone or text input/output equipment) to enable communication with a customer. Each agent is provided with one or more devices to enable interaction with an agent guidance system. For example, the device may include a processor that is configured to execute some or all functionality of an application of the agent guidance system, or may include input and output devices that are configured to communicate with one or more remote processors that are running the one or more applications of the agent guidance system.

A customer may contact the contact center of a company to request a service with regard to a product of the company. A requested service may include, for example, purchase of a product or an upgrade of a product, assistance with installation, use, of a product, troubleshooting and repairs, assistance with regard to payments (e.g., making a payment, receiving a refund, receiving an insurance payment), ordering a service (e.g., delivery or technician visit, reimbursement from an insurer, setting up an appointment or meeting), providing information, assistance with paperwork (e.g., in filling out a form), receiving a service, or other request for service that may be handled by communicating with a contact center.

During the interaction with the customer, the agent may also operate one or more processors or servers. For example, operation of the processor may include reporting the requested service (e.g., type of service, specification of product regarding which the service was requested) or contacting resources that may assist the agent in providing the requested service.

In addition to providing a requested service to the customer that has initiated contact with the contact center, an agent may be tasked with promoting sale of another product of the company. For example, the product may be one that adds value to the product concerning which the customer had requested service, or may enable the customer to avoid a problem (e.g., concerning which the customer had requested service) in the future.

Typically, an agent is trained in providing one or more types of services to customers that initiate contact with the contact center. An agent may not be trained in sales or promotion. A processor that is operated by the agent may thus be configured to run or communicate with an agent guidance system. For example, a workstation of the agent may include a display screen or other output device that is configured to communicate instructions of the agent guidance system to the agent.

One or more applications of the agent guidance system may run continuously, e.g., on a local processor of the agent's workstation or on a remote processor (any such remote processor being herein referred to as a server). Alternatively or in addition, one or more applications of the agent guidance system may run, or communication with a processor that is running an application of the agent guidance system may be initiated, in response to an action by the agent (e.g., by operation of an input device of the workstation), or in response to indication or detection of a predetermined event. For example, an event may include initiation of an interaction with the customer, indication or detection of an identity of the customer, indication of a nature of the customer's request for service, indication of completion of the requested service, or another suitable event.

The agent guidance system may present to the agent one or more options for action with regard to the interaction with the customer. For example, the agent guidance system may cause the options to be displayed on a display screen at the agent's workstation. Options may include for example a list of one or more offered products to be promoted by the agent, possible approaches to promoting an offered product, or both. With regard to each listed offered product, one or more suggested approaches to promoting the offered product may be listed. Each listed approach may include content of a statement to be made by the agent to the customer, or a suggest phrasing of the statement itself. Each such listed approach or its content may be referred herein referred to as a selling point or key selling point (KSP). A key selling point may include for example a statement of the nature of the offered product (e.g., to a customer to whom the benefits or advantages of the offered product are assumed to be self-evident), a description of a feature or advantage of the offered product (e.g., an advantage over a competing product or over a product that the customer has already acquired), an offer of promotional pricing for the offered product (e.g., discount, rebate, extended payment plan, or other pricing), an offer of related benefits or future discounts (e.g., replacement parts, service, or a warranty at a reduced price or at no cost; priority with regard to service; option to acquire upgrades or related products at a reduced price or at no cost; coupons or other promotional offers for use in acquiring related or unrelated products at a reduced or at no cost; option to return product if not satisfied; or other benefits); or other approaches, sales advice, or key selling points.

The agent guidance system may assign a rank or score to each presented option that indicates a projected effectiveness status (e.g., indicative of the likelihood of resulting in a sale) of each presented option. For example, initially, the assigned rank or effectiveness status may be arbitrary or may be assigned by a sales or marketing professional on the basis of an estimated effectiveness by the professional. As described below, the rank or score may be modified in response to feedback that is provided by agents. The ranking may be indicated in one or more ways. For example, options may be listed in order indicative of relative projected effectiveness. A projected effectiveness of an option in a displayed list may be indicated for example by a style or font of the text with which that option is displayed (e.g., size, font type, color, bold/italics, etc.), or by an associated label or symbol (e.g., that is displayed adjacent to the key selling point). A score may be indicated by providing number of agents that indicate approval or disapproval of the option.

The agent may act in accordance with one or more of the listed options. For example, the agent may relate to or tell the customer the content of a key selling point. The customer may react to the key selling point (by communicating to the agent) in a positive or negative manner. Upon receiving a negative response, the agent may counter (e.g. communicate to the customer) ending the interaction with regard to the offered product, or by communicating another key selling point with regard to the offered product. For example, the other key selling point may be designed as a rebuttal (a communication) to a received response by the customer, or may be another listed approach.

During or following the interaction, the agent may operate an input device of the agent workstation to enter feedback with regard to a key selling point. For example, the agent may note or enter a response for feedback that is received from the customer with regard to the communicated key selling point. The agent may operate an input device of the agent's workstation to inform the agent guidance system of the noted response. As another example, the agent may enter feedback in the form of an indication of approval or disapproval of the key selling point (e.g., “Like” or “Dislike” as in social networking applications).

In accordance with some embodiments of the present invention, more detailed feedback may be enabled. For example, a user interface of the agent guidance system may enable the agent to select one or more general categories or descriptions of the customer's response. Such general categories of responses may refer to, for example, agreement of the customer to purchase the offered product, expression of interest (e.g., request for more information or time to consider the offer), expression of disinterest, refusal to purchase, hostility (e.g., expressed annoyance, offense, or anger, or termination of the interaction), neutrality (e.g., noncommittal response), or other appropriate categories.

The user interface may enable the agent to enter an explanation, where known or inferred, for the customer's response to a key selling point. For example, an explanation may relate to relevance of the key selling point to the customer's perceived needs, comparison to competing offered products (e.g., offered product being more or less expensive than a similar or identical product that is offered by a competitor, special relationship with a provider of a competing product, offered product as described being more or less attractive than a competing product), clarity or comprehensibility of the key selling point (e.g., benefit of the offer is not clear from the key selling point), timing or appropriateness, or other explanation.

The agent guidance system is configured to analyze noted responses that are received from one or more agents. The analysis may include determining an indication of effectiveness, e.g., an effectiveness score, for each response. In accordance with some embodiments of the present invention, the score may simply be a number of agents who have indicated approval or disapproval of use of each key selling point. When detailed responses are enabled, an effectiveness score may be based on relative weighting of different responses. For example, an effectiveness score may be increased when presentation of a key selling point results in a positive response (where different types of positive responses may contribute differently to the score) and decreased when resulting in a negative response (where different types of negative responses may result in different reductions in the score).

As a result of the score, a listing of key selling points, or approaches or sales advice, as presented by the agent guidance system to agents may be modified. For example, a list may be modified such that a key selling point that receives a poor effectiveness score (or whose effectiveness score has been reduces due to reception of negative responses) may be ranked lower on the list than another key selling point. In accordance with some embodiments of the present invention, each listed key selling point may be accompanied by an indication of effectiveness of that key selling point. For example, the indication may include a success rate (e.g., in percent), an indication of a score or ranking (e.g., an annotation, color code, or symbol appearing in the list), an order or ranking in a displayed list, or another indication of past effectiveness.

An agent may change, emend or edit a key selling point. For example, during an interaction with a customer, an agent may discover that a modification of a formulation or phrasing of a key selling point (e.g., explicit mention of an advantage that was only implied by a formulation of the key selling point that was presented by the agent guidance system) increases the effectiveness of that key selling point. As an example, an agent may propose increasing a discount offered as part of a key selling point in order to effectively compete with a competing offer. An agent may propose reformulating a key selling point to explicitly point out a feature of the offered product that is not included in a competing product or that offers an advantage in purchasing the offered product. An agent may propose modifying phrasing of the key selling point that tends to deter that has been found to deter customers from purchasing the offered product. that may be

For example, an agent may use an input device to suggest an edit, change or emendation of a key selling point. The suggested emendation, edit or change may be presented for review. For example, the suggested emendation may be presented by the agent guidance system to a supervisor of the system. The supervisor may indicate approval or disapproval of the suggested emendation. As another example, the agent guidance system may present the suggested emendation to some or all agents of the contact center. Each agent may indicate approval or disapproval. In accordance to the indications of the agents (e.g., in accordance with number or indications, or indications that are each weighted by a factor, e.g., that is related to previous experience or performance of each agent) the formulation of the key selling point may be emended, may remain as previously formulated, the emended formulation may be listed as a separate key selling point, or the previous formulation of the key selling point with an annotation that indicates the proposed emendation.

An agent may comment on one or key selling points. For example, an agent may enter a comment (e.g. into a user interface) in the form of free text. The comment may provide an opinion regarding a key selling point, may relate experience with regard to customer reaction to the key selling point, or another comment. In accordance with some embodiments of the present invention, the comment may be viewed by a supervisor of the agent guidance system. Upon viewing, the supervisor may elect to emend a key selling point in accordance with the comment. In accordance with some embodiments of the present invention, some or all comments may be made available for review by all agents. For example, all comments may be transmitted to all agent workstations where they made be viewed by agents. As another example, a supervisor may screen comments to determine which comments are to be made available to other agents.

Agent feedback may thus be incorporated in a revised listing of options. A server of the agent guidance system may thus distribute a revised set of options for presentation to the agents.

In this manner, a list of options, e.g., including approaches, sales advice or key selling points, may be updated in real time so as to enable timely application of agent experience to an agent guidance system.

As an example of agent feedback, consider an original KSP in which the agent is instructed to tell the customer “We can offer you a 5% discount.” During interaction with the customer, the agent may discover and comment to the effect that a competitor offers a 7% discount. As a result, the KSP may be amended to“We can offer you an 8% discount.”

As another example, an original KSP may instruct the agent to tell the customer “Our package includes features A, B and C.” During interaction with the customer, the agent may discover and comment to the effect that a competitor's package does not include feature C. As a result, the KSP may be amended to“Our package includes features A and B, and above all feature C which is unique to our company.”

As another example, an original KSP may instruct the agent to tell the customer “I can see that you are paying for double package, but the triple package may be a better fit.” During interaction with the customer, the agent may discover and comment to the effect that one or more customers negatively perceive the offer of a product “the triple package” as an attempt to sell a more expensive product. As a result, the KSP may be amended to “I can see that you are paying for double package. Have you heard about feature C . . . .?”As another example, an original KSP may instruct the agent (e.g., an airline representative) to ask the customer “Would you like us to transfer you to one of our partners for hotel booking?” During interaction with one or more customers, the agent may discover and comment to the effect that a customer reacts positively to the offer only upon realizing that the offer gives bonus miles. As a result, the KSP may be amended to “ You are eligible to earn bonus miles when you book a hotel. would you like me to transfer you to one of our partners?”

An agent guidance system may include (e.g., gamification) features to encourage, or provide incentives, to promote agent action in accordance with suggested options. For example, the agent guidance system may list a sales goal or otherwise encourage the agent to act in accordance with the suggested options.

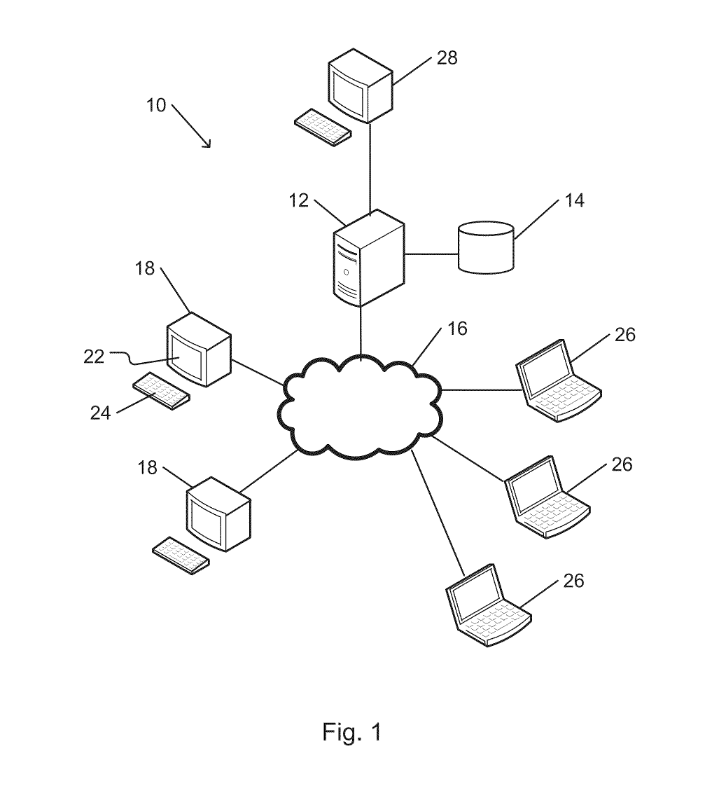

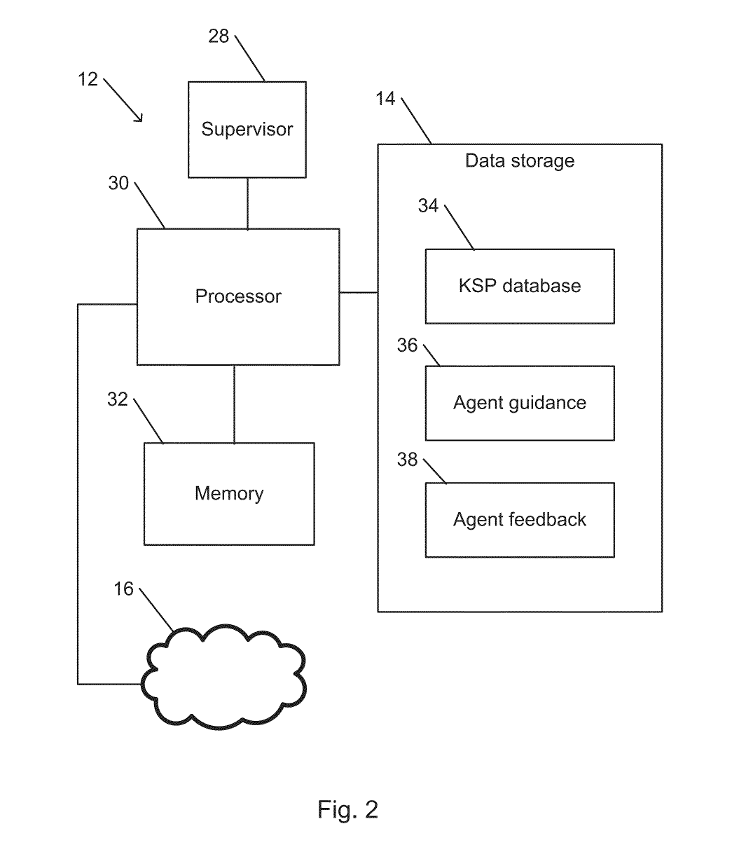

FIG. 1 is a schematic illustration of a system for contact center agent guidance, in accordance with an embodiment of the present invention. FIG. 2 is a schematic illustration of a server of the system shown in FIG. 1.

Contact center agent guidance system 10 may be incorporated into, or configured to interact with, a system for enabling or facilitating operation of a contact center. For example, a contact center operation system may detect initiation of an interaction by a customer device 26 (e.g., an incoming telephone call or online logon), select an agent to continue the interaction, and connect the agent workstation 18 of the selected agent to the customer device 26.

Contact center agent guidance system 10 may include guidance server 12. Guidance server 12 may communicate via network 16 with a plurality of agent workstations 18. An agent workstation 18 may communicate via network 16 with one or more (typically, at a given time, one of a plurality of) customer devices 26. For example, network 16 may include a wired or wireless network that enables communication between guidance server 12 and agent workstations 18. Network 16 may include a dedicated network for agent guidance, a network of a company that is represented by agents that are associated with agent workstations 18, a telephone network, the Internet, or another network suitable for communication between guidance server 12 and agent workstations 18. Network 16 may include a plurality of different networks. For example, communication between agent workstation 18 and guidance server 12 may use one network of network 16, while communication between agent workstation 18 and customer device 26 may use another network.

Agent workstation 18 includes one or more devices that enable communication between an agent operating agent workstation 18 on the one hand, and guidance server 12 or customer device 26 on the other. Agent workstation includes one or more devices capable of connecting to, and communicating via, network 16. For example, agent workstation 18 may include one or more of a stationary or mobile computer, a telephone, a smartphone, a network terminal, or another suitable device. In some cases, a telephone may be used for communication with a customer device 26, and a computer for communication with guidance server 18. In other cases, a single device (e.g., computer or smartphone) may be used for both. Other combinations of devices may be used. Agent workstation 18 may incorporate a processor, or may be configured to communicate with a remote processor.

Agent workstation 18 includes an output device 22. Output device 22 may be operated, e.g., by a processor of agent workstation 18 or by server 12, to present information to an agent operating agent workstation 18. The presented information may include, for example, list of options approaches, sales advice or key selling points, Output device 22 may be or include for example a computer monitor or screen. Output device 22 may include a receiver of a telephone handset. In another example, output device 22 may include a printer, display panel, speaker, or another device capable of producing visible, audible, or tactile output, or otherwise capable of presenting information to an agent operating agent workstation 18.

Agent workstation 18 includes an input device 24. Input device 24 may be operated to input data, e.g., for transmission to server 12. For example, input information may include an evaluation of a key selling point or a report regarding a customer's response. Input device 24 may include one or more of a keyboard, keypad, touch-sensitive screen, pointing device, microphone, a transmitter of a telephone handset, or other device that may be operated by an agent operating agent workstation 18 to input information or data. Input device 24 and output device 22 may form a user interface e.g. by displaying information to a user and allowing for input.

Guidance server 12 may include processor 30. Processor 30 may include one or more intercommunicating processing units, e.g. of one or more computers. Processor 30 may be configured to operate in accordance with programmed instructions stored in memory 32 to for example carry out methods according to embodiments of the invention. Processor 30 may be capable of executing an application related to agent guidance.

Processor 30 may communicate with a storage medium such as memory 32. Memory 32 may include one or more volatile or nonvolatile memory devices. Memory 32 may be utilized to store, for example, programmed instructions for operation of processor 30, data or parameters for use by processor 30 during operation, or results of operation of processor 30

Processor 30 may communicate with data storage device 14. Data storage device 14 may include one or more fixed or removable nonvolatile data storage devices. For example, data storage device 14 may include a non-transitory computer readable medium (e.g., memory 32) for storing program instructions for operation of processor 30. The programmed instructions may include an agent guidance module 36 for providing guidance options to an agent workstation 18, and an agent feedback module 38 for soliciting and receiving feedback from agent workstations 18. The programmed instructions may include other modules or provide other functionality.

Data storage device 14 may be remote from processor 30. In such cases data storage device 14 may be a storage device of a remote server storing programmed instructions in the form of an installation package or packages that can be downloaded and installed for execution by processor 30. Data storage device 14 may be utilized to store data or parameters for use by processor 30 during operation, or results of operation of processor 30. For example, data storage device 14 may be utilized to store key selling point (KSP) database 34.

KSP database 34 may include one or more lists of key selling points approaches or sales advice that are associated with one or more offered products. KSP database may include agent feedback regarding each listed key selling point, or one or more values representing a result of analysis of agent feedback. KSP database 34 may include a unique identifier and a revision number of each listed key selling point. For example, if a key selling point is modified, the unique identifier may remain constant while the revision number is incremented.

Processor 30 of guidance server 12 may communicate with supervisor workstation 28. For example, a supervisor (e.g., a sales or marketing professional) may operate supervisor workstation 28 to review comments or other feedback that are provided by agent workstations 18. A supervisor may operate supervisor workstation 28 to create or modify key selling points, to initially assign or to modify effectiveness ratings or priorities to key selling points, to set sales goals (e.g., for the purpose of gamification of agent tasks), to create or modify a list of offered products, to review agent feedback, to review agent performance, or for other purposes.

A customer device 26 may include one or more devices that enable a customer to communicate with an agent workstation 18 via network 16. For example, customer device 26 may include one or more of a telephone, smartphone, stationary or mobile computer, or other device.

In operation, processor 30 may execute a method for agent guidance.

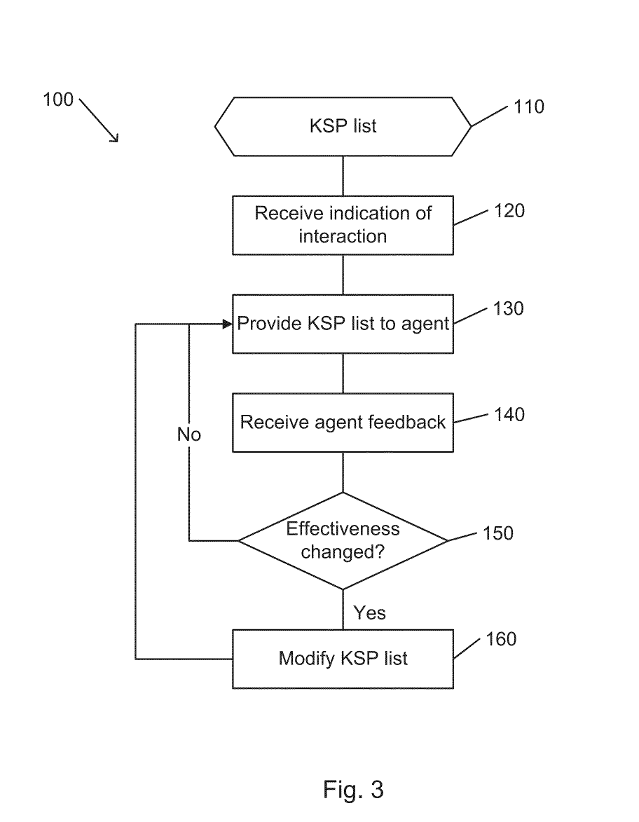

FIG. 3 is a flowchart of a method for agent guidance, in accordance with an embodiment of the present invention.

It should be understood with respect to any flowchart referenced herein that the division of the illustrated method into discrete operations represented by blocks of the flowchart has been selected for convenience and clarity only. Alternative division of the illustrated method into discrete operations is possible with equivalent results. Such alternative division of the illustrated method into discrete operations should be understood as representing other embodiments of the illustrated method.

Similarly, it should be understood that, unless indicated otherwise, the illustrated order of execution of the operations represented by blocks of any flowchart referenced herein has been selected for convenience and clarity only. Operations of the illustrated method may be executed in an alternative order, or concurrently, with equivalent results. Such reordering of operations of the illustrated method should be understood as representing other embodiments of the illustrated method.

Agent guidance method 100 may be executed for example by a processor, e.g., processor 30 (FIG. 2) of a server of an agent guidance system. Execution of agent guidance method 100 may be initiated by a supervisor of the agent guidance system, or may be initiated automatically in response to a predetermined event. For example, execution of agent guidance method 100 may be initiated upon commencement of activity of a contact center, upon commencement of activity of an agent workstation, upon indication of initiation of an interaction by a customer, upon commencement of an interaction between an agent and the customer, at predetermined times, or in response to another event. Agent guidance method 100 may be in relation to all agents of a contact center, a subset of the agents of a contact center, or in relation to a single agent.

Agent guidance method 100 may include accessing a list of key selling points for one or more offered products (block 110). The list of key selling points may include an indication of an effectiveness status or priority based on an estimated or measured effectiveness of each key selling point of the list. Key selling points may have been entered and their priorities determined by a supervisor of an agent guidance system, by an agent of the contact center, automatically by the agent guidance system, or otherwise. Accessing the list of key selling points may include retrieving the key selling points (with their priorities) from a database.

An indication may be received that an interaction of a customer with an agent has commenced (block 120). For example, the agent may operate an input device of an associated agent workstation to indicate a start of the interaction. As another example, a contact center system may indicate that a customer device has been connected to an agent workstation.

The list of key selling points or sales advice may be provided to the agent involved in the interaction (block 130). For example, the full list of key selling points, or a subset of the list, may be presented to the agent via an output device of an agent workstation that is associated with the agent. A subset of the list may include those key selling points that are determined to be relevant to an identified customer. For example, the list of key selling points may be presented prior to the interaction, concurrent with starting the interaction, or during the course of the interaction (e.g., upon indication of completion of provision of a service that was requested by the customer). The listed key selling points may include rebuttals or counterpoints to particular anticipated responses of a customer to a presented key selling point.

Upon being presented with the list of key selling points, the agent may select one or more of the key selling points for use during the interaction. For example, the agent may recite (e.g., substantially verbatim or paraphrased) a listed key selling point to the customer, or may base a message that is transmitted to the customer on an idea that is expressed in a key selling point.

The agent may note which key selling points, when presented to the customer, had a positive effect (e.g., persuaded the customer to purchase the offered product, increased the customer's interest in the offered product, elicited positive statements, resulted in the customer extending the interaction, or otherwise engendered or fostered a perceived favorable attitude of the customer toward the offered product, the agent, or the company), had a negative effect (e.g., caused the customer to decide against purchase of the offered product, reduced customer's interest in the offered product, resulted in termination of the interaction by the customer, elicited negative statements from the customer, or was otherwise perceived as engendering a negative attitude of the customer toward the offered product, the agent, or the company), or a neutral effect (e.g., no perceived change in the customer's attitude).

The agent may enter feedback with regard to each key selling point used. The agent may also enter feedback with regard to a key selling point that was considered for use by the agent, but whose use was rejected by the agent. For example, entered feedback may include an indication of approval or disapproval of a key selling point. Entered feedback may include a specification of a nature of the customer's response to the key selling point, a suggestion for emendation of the key selling point, or a comment related to the key selling point.

The feedback that is entered by the agent may be received (block 140). The received feedback includes an indication of the listed key selling point to which the feedback pertains. The indication may include for example one or more of a unique identifier, a revision number, a text of the key selling point, an indication of a location of the key selling point on the list, or other indication of the key selling point to which the feedback pertains. The received feedback includes an indication of the content of the feedback (e.g., approval, disapproval, nature of response, text of emendation or comment, or other indication of content).

An analysis may be performed on the received feedback to determine whether the feedback indicates a change in effectiveness status (or priority) of the key selling point (block 150). For example, an indication of approval or disapproval may be added to a tally of previously received indications from the same agent, or from another agent. Similarly, a formula, algorithm, lookup table, or other analysis may be applied to an indicated customer response to determine a new effectiveness score or priority for the key selling point. A change in effectiveness status may be created or indicated, for example, by any new feedback (e.g., when effectiveness status is indicated simply by a total of indications of approval or disapproval, e.g., number of “Likes” or “Dislikes”), when a threshold change in an effectiveness score is exceeded, when the feedback causes a priority of the key selling point to overtake or be overtaken by a priority of another key selling point on the list, or in another manner.

If no change in effectiveness status is indicated, the existing list of key selling points continues to be provided to agent workstations (returning to block 130).

When a change in effectiveness status is indicated, the list of key selling points is modified to incorporate the change in effectiveness status (block 160). For example, an order of listed key selling points may be modified to reflect a change in priorities. Another indication of effectiveness status (e.g., score, label, marking, font, or other indication) may be modified. For example, a displayed or presented total of indications of approval or disapproval may be updated. A text of a key selling point may be modified (e.g., with or without supervisor intervention. A priority of effectiveness status may be modified by a supervisor in response to a comment.

The modified list of key selling points may be distributed to agents (returning to block 130). For example, the modified list may be immediately or in real time, or at a later time, transmitted to all agent workstations, to a subset of agent workstations, or to agent workstations when needed (e.g., when beginning a new interaction, upon completion of providing a requested service to a customer, or upon occurrence of another event).

In this manner, a list of key selling points may be updated in real time in response to feedback relating to effectiveness of a selling point that is received from agents of a contact center.

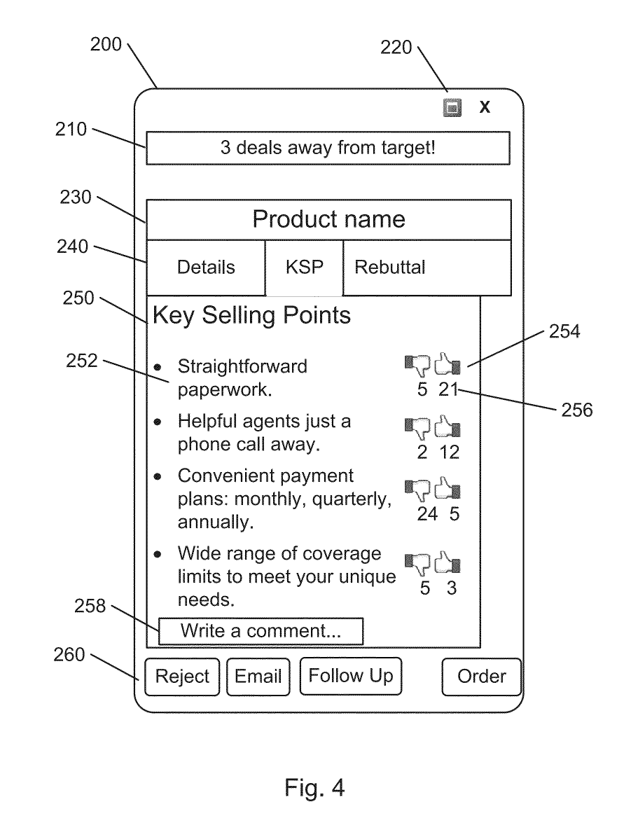

FIG. 4 is a schematic illustration of a user interface for contact center agent guidance that incorporates agent feedback, in accordance with an embodiment of the present invention.

User interface 200 may be displayed on a display screen of a user workstation. User interface 200 may enable a user to control operation of an agent guidance program. User interface 200 may include controls 220 for controlling display or for termination of operation of the agent guidance program (e.g., controls to minimize, maximize, close, open, scroll, or otherwise affect display or operation of user interface 200).

User interface 200 may include a message area 210. Message area 210 may display messages from an agent guidance system to an agent. For example, the messages may be related to gamification (e.g., incentive to the agent).

User interface 200 may include a product name region 230 for displaying the name of a product regarding which guidance is being provided. For example, the product may be a product which the agent is requested to offer to the customer. Tabs 240 may be selected to display different categories of guidance. For example, categories of guidance may include a detailed description of the product, key selling points regarding the product, suggested rebuttal arguments in reply to a customer response, or other categories.

For example, selection of a key selling point (KSP) tab from tabs 240 may open a key selling point box 250. Key selling point box 250 displays one or more key selling points 252. Key selling point box 250 may include screen controls that are selectable by an agent to provide feedback with regard to each key selling point 252. For example, screen controls may include one or more approval/disapproval controls 254. Selection of one of approval/disapproval controls 254 may indicate that the agent has found the associated key selling point 252 to be useful or not useful in promoting a product to a customer. Key selling point box 250 may include an approval indication 256 regarding how many agents (or how many times a smaller number of agents) indicated approval or disapproval of the associated key selling point 252. A comment control 258 may be selected to enable the agent to enter a comment (e.g., either free text or selected from a list) with regard to one or more of the displayed key selling points 252.

A key selling point box 250 may include other or additional types or combinations of controls form indicating feedback. For example, only approval or disapproval may be noted. Instead of a number of times approval or disapproval was indicated, a score or ranking based on previous agent responses may be displayed. An order in which key selling points 252 are displayed in key selling point box 250 may be indicative of relative approval score of the key selling points 252.

User interface 200 includes response controls 260 to enable the agent to indicate a customer response to a product offer, or recommended action with regard to a customer response to a product offer. For example, the agent may select one of response controls 260 to indicate that the customer has rejected the offer (e.g., no further action being necessary), that an email should be sent to the customer (e.g., opening a dialog that enables the agent to send the required email, e.g., with attached information), that follow-up action is required (e.g., opening a dialog to enter a reminder to perform the follow-up action, or to request another party to perform the follow-up action), that the customer has agreed to accept the offer (e.g., opening a dialog to enter details of the order and to place the order), or another response.

Embodiments of the invention may include a storage medium, for example a non-transitory computer readable storage medium, having stored thereon instructions that when executed by a processor will cause the processor to perform methods disclosed herein.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

Various embodiments have been presented. Each of these embodiments may of course include features from other embodiments presented, and embodiments not specifically described may include various features described herein.

1. A method for providing guidance to agents of a contact center, the method comprising:
providing by a server of an agent guidance system a list of key selling points to a plurality of workstations, each of the workstations associated with an agent of the agents of the contact center, each key selling point of the list being associated with an effectiveness status;
receiving by the server from a workstation of said plurality of workstations feedback related to an effectiveness of a key selling point of the list;
automatically modifying the effectiveness status of a key selling point of the list in accordance with the received feedback; and
providing by the server to said plurality of workstations a modified list that incorporates the modified effectiveness status.

2. The method of claim 1, wherein a position of a key selling point of the list within the list indicates an effectiveness status that is associated with that key selling point.

3. The method of claim 1, wherein providing the list of key selling points comprises displaying the list on an output device of a workstation of said plurality of workstations.

4. The method of claim 3, wherein a font with which a key selling point of the list is displayed is indicative of the effectiveness status of that key selling point.

5. The method of claim 1, wherein the effectiveness status of a key selling point of the list comprises a number of agents that have indicated approval of that key selling point.

6. The method of claim 5, wherein receiving the feedback comprises receiving an indication of approval or of disapproval.

7. The method of claim 6, wherein providing the list of key selling points comprises displaying a number of the received indications of approval or of disapproval.

8. The method of claim 6, wherein providing the modified list comprises updating a presented total of indications of approval or of disapproval.

9. The method of claim 1, wherein receiving the feedback comprises receiving a comment.

10. The method of claim 9, further comprising forwarding the received comment to a supervisor workstation.

11. The method of claim 1, wherein the effectiveness status is initially determined at a supervisor workstation.

12. A non-transitory computer readable storage medium having stored thereon instructions that when executed by a processor cause the processor to perform the operations of:
providing a list of key selling points to a plurality of workstations, each of the workstations associated with an agent of the agents of the contact center, each key selling point of the list being associated with an effectiveness status;
receiving from a workstation of said plurality of workstations feedback related to an effectiveness of a key selling point of the list;
modifying the effectiveness status of a key selling point of the list in accordance with the received feedback; and
providing to said plurality of workstations a modified list that incorporates the modified effectiveness status.

13. The computer readable storage medium of claim 12, wherein the instructions include instruction to display the list or the modified list so as to indicate the effectiveness status of a key selling point of the list.

14. The computer readable storage medium of claim 13, wherein the effectiveness status is indicated by a position of that key selling point in the displayed list or modified list, or by a displayed number of received indications of approval.

15. The computer readable storage medium of claim 12, wherein the instructions for receiving feedback include instruction to receive an indication of approval or disapproval from a workstation of said plurality of workstations.

16. An agent guidance system comprising:
a computer readable medium; and
a processor of a server, the processor being in communication with the computer readable medium, wherein the computer readable medium contains a set of instructions which when executed by the processor cause the processor to:
provide a list of key selling points to a plurality of workstations in communication with the server, each of the workstations being connectable via a network to a customer device, each key selling point of the list being associated with an effectiveness status;
receive from a workstation of said plurality of workstations feedback related to an effectiveness of a key selling point of the list;
modify the effectiveness status of a key selling point of the list in accordance with the received feedback; and
provide to said plurality of workstations a modified list that incorporates the modified effectiveness status.

17. The system of claim 16, further comprising a supervisor workstation in communication with the server.

18. The system of claim 16, wherein a workstation of said plurality of workstations comprises an output device for displaying the list or the modified list.

19. The system of claim 16, wherein a workstation of said plurality of workstations includes an input device for enabling an agent that operates the station to enter the feedback

20. The system of claim 16, wherein the network comprises a telephone network.
